(19) United States
(12) Patent Application Publication
(10) Pub. No.: US 2017/0138195 A1
(43) Pub. Date: May 18, 2017

(54) ENHANCED WASTE HEAT RECOVERY SYSTEM

(71) Applicant: Dana Limited, Maumee, OH (US)

(72) Inventor: Mark R.J. Versteyhe, Oostkamp (BE)

(21) Appl. No.: 15/371,883

(22) Filed: Dec. 7, 2016

Related U.S. Application Data
(63) Continuation-in-part of application No. 14/392,078, filed on Sep. 11, 2015, now abandoned.
(60) Provisional application No. 61/777,305, filed on Mar. 12, 2013.

(51) Int. Cl. F01B 3/10; F01B 21/02; F01K 23/06; F02G 5/04

(52) U.S. Cl. CPC F01B 3/102; F02G 5/04; F01B 21/02; F01K 23/065

(57) ABSTRACT

A method for improving the efficiency of an internal combustion engine changes the volume in a piston chamber of an expander device. The expander device generally operates at a fixed expander device speed to perform work on an expander shaft. The expander shaft is connected to a first end of a piston in the piston chamber.

### RELATED APPLICATIONS

The present application is a continuation-in-part application of U.S. patent application Ser. No. 14/392,078 filed on Sep. 11, 2015 and currently pending. U.S. patent application Ser. No. 14/392,078 claims priority to and the benefit from Provisional U.S. Patent Application Ser. No. 61/777,305 filed on Mar. 12, 2013. The content of the above-noted patent applications are hereby expressly incorporated by reference into the detailed description of the present application.

### BACKGROUND FOR THE PRESENT DISCLOSURE

Conventional internal combustion engines (ICE) have a limited brake thermal efficiency (BTE). The energy produced during the combustion process can only partially be converted to useful work. Most of the fuel energy is being rejected as waste heat in the exhaust gases. It would be preferable to capture or recover some or all of the waste heat from the exhaust gases to improve the thermal efficiency of the engine, thus lowering fuel consumption and lowering CO2 emissions.

### SUMMARY OF THE PRESENT DISCLOSURE

A method for improving the efficiency of an internal combustion engine including changing the volume in a piston chamber of an expander device having a fixed expander device speed to make the expander device perform work on a expander shaft connected to a first end of a piston on said piston chamber; and selectively opening a fluid inlet port into said piston chamber when said piston reaches a predetermined point in said piston chamber axially away from a piston top dead point to permit vapor into said piston chamber thus changing the volume of the piston chamber, said vapor moving said piston axially away from said predetermined point.

Additionally disclosed is a positive displacement expander device including a piston chamber, a piston located within said piston chamber, an expander shaft connected to both a swash plate connected to said piston and a rotating inlet disk, wherein said rotating inlet disk has an inlet port selectively matched with said piston chamber inlet opening and an outlet port selectively matched with said piston chamber inlet opening.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a schematic embodiment of one embodiment of a waste heat recuperation system;

FIG. 2A is a pressure verses volume chart for a waste heat recuperation system depicting under expansion losses;

FIG. 2B is a pressure verses volume chart for a waste heat recuperation system depicting over expansion losses;

FIG. 3 is a schematic, partial cut away side view of one embodiment of a fixed volume swash plate piston expander;

FIG. 4 is a pressure verses volume graph depicting a first cycle for a non-variable expander device and which also depicts a second cycle for a variable expander device;

FIG. 4A is a volume verses displacement graph for the non-variable expander device of FIG. 4;

FIG. 4B is a port status verses time graph for the non-variable expander device of FIG. 4;

FIG. 4C is a volume verses displacement graph for the variable expander device of FIG. 4;

FIG. 4D is a port status verses timing graphs for the variable expander device of FIG. 4;

FIG. 5 is a schematic, partial cut away side view of one embodiment of a variable volume swash plate piston expander; and

FIG. 6 is a pressure verses volume chart depicting the difference between a fixed volume swash plate piston expander and a variable volume swash plate piston expander.

### DETAILED DESCRIPTION OF THE EXEMPLARY EXAMPLES

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts of the present invention. Hence, specific dimensions, directions or other physical characteristics relating to the embodiments disclosed are not to be considered as limiting, unless expressly stated otherwise.

At least a portion of the waste heat energy from an internal combustion engine can be recovered by using a waste heat recuperation cycle. One example of such a cycle, to which the present disclosure is not limited, might be such as an Organic Rankine Cycle (ORC).

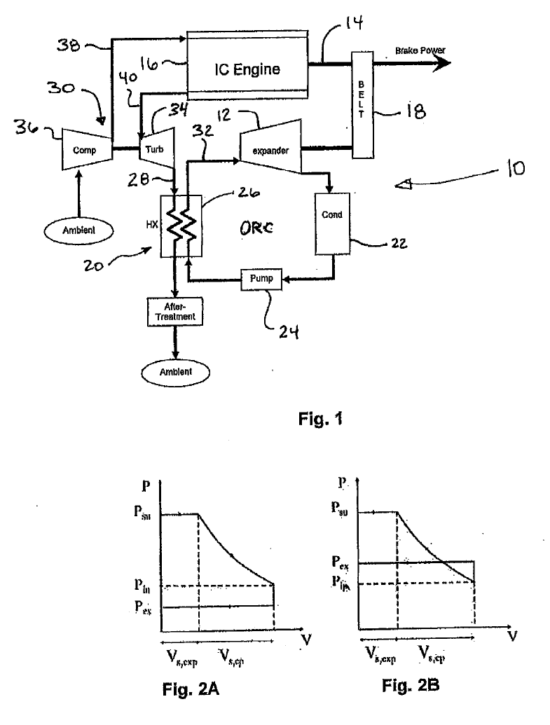

One embodiment of a Waste Heat Recovery (WHR) system 10 is depicted in FIG. 1. In FIG. 1, a positive displacement expander device 12 in the system 10 is directly mechanically coupled to a crankshaft 14 of an ICE 16 by a belt or gear box 18. Through this connection, the expander device 12 can supply additional torque and power to the crankshaft 14. By connecting the expander device 12 to the ICE 16, the overall thermal efficiency of the ICE 16 is improved, resulting in lower fuel consumption and lower CO2 emissions.

While this specification will use the example of an expander device 12, it can be appreciated that the concepts discussed herein can also be adapted to compressors.

The WHR system includes a heat capturing circuit 20, the positive displacement expander device 12, a condenser 22, a feed pump 24 and a working fluid. The working fluid is a 2-phase fluid fitting the temperature range of the waste heat flows of the ICE or a mixture of such fluids. In most embodiments, the two phases for the fluid are liquid and gas or vapor.

The pump 24 moves the fluid from device to device as shown in FIG. 1. The condenser 22 condenses the fluid after it performs work in the expander device 12.

The heat capturing circuit 20 comprises a heat exchanger 26 and fluid lines leading into and away from the heat exchanger 26. A first line 28 brings fluid into the heat exchanger 26 from a turbocharger 30. The turbocharger 30 is connected to the ICE 16. The first line 28 exits the heat exchanger 26 where it extends to an after-treatment. The after-treatment may be such as, but not limited to, a particle filter, a catalytic converter and/or a selective catalytic reduction device.

A second line 32 connects the positive displacement expander device 12, the condenser 22 and the pump 24 with the heat exchanger 26. While “a second line” and “a first line” are used above, and suggest each is an individual line, it can be appreciated that the multiple lines may comprise the “a first line” or the “a second line.”

In one embodiment, such as depicted in FIG. 1, the first line 28 in the heat exchanger 26 contains the waste heat flow from the ICE 16 via the turbocharger 30. Within the heat exchanger 26, the first line 28 can extend in any manner, which may include curvilinear. The first line 28 may also branch into multiple lines within the heat exchanger 26.

The second line 32 may also extend within the heat exchanger 26 in any manner, including curvilinear. The second line 32 may also branch into multiple lines within the heat exchanger 26.

Regardless of the size, shape or design of the first or second lines 28, 32 within the heat exchanger 26, it is preferred that they be adjacent, or in contact with one another, so that heat from the first line 28 gets exchanged to the second line 32 through convection, conduction and/or radiation.

The heat from the first line 28 turns the fluid in the second line 32 into a gas or vapor. The vapor travels through the second line 32 to the positive displacement expander device 12. The vapors are expanded in the device 12 to generate useful work that can be sent to the driveline.

As stated above, in the depicted embodiment, the heat exchanger 26 receives heated fluid in the first line 28 from the ICE via a turbocharger 30. The turbocharger 30 may be comprised of a turbine 34, which is connected to a compressor 36. The compressor 36 provides compressed air to the ICE 16, as shown via a line 38 connecting the compressor 36 to the ICE 16. The compressed air is denser than ambient air, which makes the ICE 16 more efficient when operating and more powerful as more air enters the combustion chambers. The ICE 16 in turn delivers heated exhaust gases to the turbine 34 via a line 40 connecting the ICE 16 and the turbine 34. The turbine 34 converts the heated exhaust gases into rotational energy which is then mechanically routed to the compressor 36. While a turbocharger 30 is discussed and depicted herein, it can be appreciated that the present waste heat recovery system 10 can operate in substantially the same way without it.

Usually the WHR system 10 will be designed to perform optimally at the normal operating point of the ICE 16 resulting in an optimal evaporation pressure and temperature in the heat exchanger 26 and an optimal mass flow for the working fluid according the normal engine speed and load. Optimization can be achieved by utilizing the appropriate size and type of the heat exchanger 26, condenser 22, pump 24 and expander device 12 for the operating conditions of the vehicle.

The ICE 16, however, can also operate under highly dynamic conditions, such as highly variable engine speeds and engine loads resulting in dynamic operating conditions for the WHR system 10. Under these conditions, the mass flow rate and/or evaporation pressure and temperature of the working fluid have to be controlled to maximize the power generated by the WHR system 10.

In the embodiment where the positive displacement expander device 12 is connected directly with a belt, or gear box 18 to the ICE 16, and more particularly, the ICE crankshaft 14, the expander device 12 and the engine speed have a fixed speed ratio. It can be appreciated that in this circumstance, the mass flow rate of the working fluid cannot be controlled independently from the engine speed for an expander device 12 with a fixed displacement. In this condition, a non-optimal evaporation pressure in the heat exchanger 26 occurs. It can be appreciated that if the fluid is not optimally evaporated in the heat exchanger 26, it will not perform the same work in the expander device 12, thus making the WHR system less efficient than it can be.

Continuing with this example, when a vehicle is driving at constant speed, and the slope of the road increases, the load on the ICE 16 also increases. An increased engine load results in a higher fuel consumption and so more thermal energy can be recovered in the exhaust gases. In order to optimize the waste heat recovery, the mass flow rate of the working fluid has to increase when operating the WHR system 10 at constant and optimal working conditions. As the ICE 16 and positive displacement expander device 12 are operating at constant speed, the mass flow rate cannot be altered over the expander device 12 resulting in an increase of the heat exchanger pressure. As the expander device 12 has a fixed displacement and expansion ratio, an increase of the expander device 12 inlet pressure will cause an increase of the under expansion losses and thus will lower the conversion efficiency of the WHR system 10, which can be appreciated by FIG. 2A. FIG. 2B shows the opposite — which is the situation where the fluid is over-expanded. This situation is also undesirable since it reduces the amount of work available to be executed from the fluid.

In FIGS. 2A and 2B, the following chart references are used, which are defined below:

Pₑₓ is the pressure at the exhaust of the working fluid, when a piston chamber is open to an outlet;

Pᵢₙ is the pressure at the end of the expansion phase in the piston chamber;

Pₛᵤ is the suction pressure, thus the pressure of the fluid that enters a piston chamber;

V_{s,exp} is the dead volume which cannot be used; and

V_{s,cp} is the usable volume that the piston will cover.

Similar rationale can be applied in the case of variable engine speed or other dynamic operation conditions of the ICE and WHR system. In order to maximize the conversion efficiency of the WHR system, the mass flow rate of the working fluid and/or the heat exchanger pressure has to be controlled independently of the engine speed.

The device and method described herein utilizes the structure depicted in FIG. 1 to overcome the shortcomings discussed above by controlling the thermal cyclic process of the positive displacement expander device 12 in the WHR system 10. More specifically, the mass flow rate of the positive displacement expander device 12 is controlled and the pressure level of the working fluid in the waste heat exchanger device 12 is controlled.

The positive displacement expander device 12 works by a vapor filling up a fixed volume, such as a piston chamber. The vapor is supplied by the heat exchanger 26, as described above. After the piston chamber volume is closed, the vapors are trapped and force a displacement, or expansion, of the piston. The piston, or pistons as the case may be, deliver work to an expander shaft attached to the piston making the expander shaft rotate.

As indicated above, the positive displacement expander device 12 is directly mechanically coupled to the ICE crankshaft 14 by the belt, or gear box, 18. It can therefore be appreciated that the torque generated by the expander device 12 is added to the ICE crankshaft 14, thus increasing the power output of the engine. By controlling the moment when an inlet opening to the ICE piston chamber is opened for the vapor to enter the chamber, the over- and under- expansion losses can be minimized and therefore the expander device power output can be maximized.

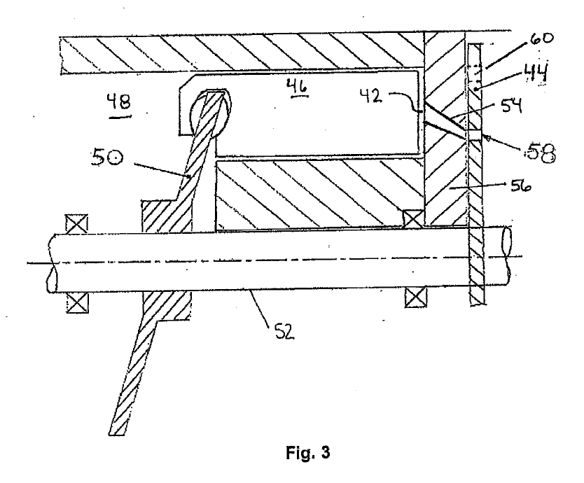

A piston chamber inlet opening 42 for a fixed displacement axial piston expander device 12 can be controlled with a rotating inlet disk 44, as depicted in FIG. 3. FIG. 3 schematically depicts one piston 46 within a piston chamber 48. A swash plate 50 is pivotally connected at one end of the piston 46. When vapor is introduced into the piston chamber 48 through the inlet opening 42, it forces the piston 46 in the axial direction away from the inlet opening 42. The axial movement of the piston 46 translates to the swash plate 50, which, via its pivotal connection to the piston 46 converts the axial movement into a rotational force.

The swash plate 50 is connected to an expander shaft 52. The rotational force from the swash plate 50 translates to the expander shaft 52 to rotate the shaft 52. The shaft 52 can be directly or indirectly connected to the above-mentioned belt, or gearing, 18.

In the depicted embodiment, the inlet opening 42 is located opposite the connection of the piston 46 to the swash plate 50. The opening 42 leads to a channel 54 through the piston chamber wall 56. The channel 54 is shown as being tapered and directed downwardly, but other shapes, sizes and directions are permissible.

In one embodiment, the piston chamber channel 54 is selectively aligned with an inlet port 58 on the rotating inlet disk 44. During steady state operations, the rotating inlet disk 44 is synchronized with the displacement of the piston 46. The inlet disk 44 is mounted on the same shaft 52 as the swash plate 50. While the inlet disk 44 is shown on a one-piece shaft 52 shared with the swash plate 50, the shaft 52 can be more than one piece or comprised of a mechanical connection that provides the same effect.

Generally, during steady state operation, the inlet disk 44 rotates with the shaft 52 at the same speed as the swash plate 50. However, the inlet disk 44 may rotate at a different speed than the swash plate 50 in order to create a delay or lag in the alignment of the inlet port 58 and the inlet opening 42. In that case, the inlet disk 44 rotates at a different speed, i.e. a transition speed, until a predetermined lag in the alignment of the inlet port 58 and the inlet opening 42 with respect to the piston displacement is achieved.

The rotating inlet disk 44 speed can be varied using a power source connected to the rotating inlet disk 44 including, but not limited to, an electric motor. To adjust the speed of the rotating inlet disk 44 to achieve the desired lag, the rotational position of the swash plate 50 is measured and the speed of the rotating inlet disk 44 is controlled using a controller. The controller controls the inlet disk 44 speed and can impose an instantaneous change in speed using the power source in comparison to the swash plate 50 speed. In steady state operation, the controller can also track the speed of swash plate 50.

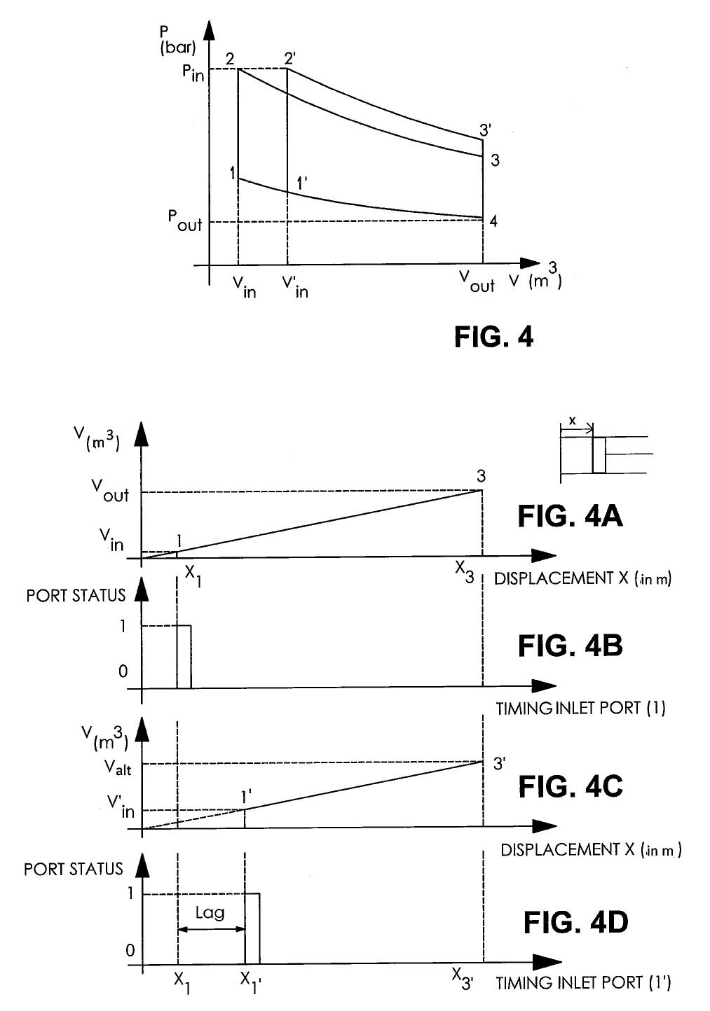

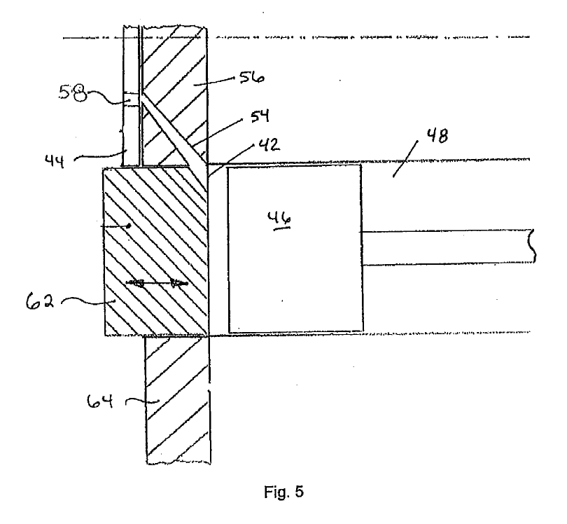

The cycle of the expander device 12 described above is represented in a pressure verses volume diagram shown in FIG. 4. During steady state operation, when the piston 46 reaches its top dead point (1), i.e. the position where the piston 46 is closest to the piston chamber wall 56, also known as top dead center, the inlet port 58 in the rotating inlet disk 44 is aligned with the inlet opening 42 of the piston chamber 48 thus permitting the working vapor to fill the clearance volume, which is represented by Vᵢₙ in FIG. 4. Further, the volume verses piston displacement is charted in FIG. 4A, while the status of the port verses the timing of the inlet port is plotted in FIG. 4B. The inlet port 58 status is represented by a zero when closed and a one when open in FIG. 4B.

The WHR working vapor enters the clearance volume Vin at the top dead point at the inlet pressure pin (2). As the piston 46 moves backwards, the inlet disk 44 rotates and closes the piston chamber 48. The working vapor expands in the piston chamber 48 until a bottom dead point (3) of the piston 46 is reached, i.e. where the piston 46 is furthest from the piston chamber wall 56, at which point an outlet port 60 opens.

The outlet port 60 is also carried on the inlet disk 44. The outlet port 60 may be positioned on the inlet disk 44 azimuthally any amount from the inlet port 58. The azimuth distance between the inlet port 58 and the outlet port 60 is dependent upon size of the piston chamber 48 and the stroke of the piston 46.

At the bottom dead point (3), the vapor exits the piston chamber 48 and the fluid exits towards the condenser, the pressure drops to the outlet pressure pout (4). Then the piston 46 moves forward and compresses the vapor left behind in the piston chamber 48 until the top dead point (1) is reached again and the cycle restarts.

As the expander device 12 has a fixed piston displacement, the volume, and mass flow rate of the expander device 12 is also fixed for a given expander device 12 speed when the rotating inlet disk 44 is rotating at the same speed as the shaft 52.

A way to alter the volume, or mass flow rate, at a given expander device 12 speed is to let the rotating inlet disk 44 lag relative to the piston displacement such that the inlet port 58 of the rotating inlet disk 44 is not aligned with the piston inlet chamber opening 42 at the top dead point (1). This situation is also depicted on FIG. 4, as well as FIGS. 4C and 4D, which are described below.

When the alignment of the inlet opening 42 and the inlet port 58 is not synchronized with the top dead point (1) of the piston 46, at the top dead point (1) of the piston, the inlet port 58 is still closed. As the piston 46 starts to move backwards and only when the piston 46 reaches a new predetermined point (1′) does the inlet port 58 and the inlet opening 42 align. Now the working vapor fills an adjusted clearance Vin that corresponds to the volume of the piston chamber 48 when the piston 46 is at the predetermined point (1′) at the inlet pressure pin (2′) as illustrated in FIG. 4. The vapor expands until the piston bottom dead point is reached (3′) at which point the outlet port 60 opens and the vapor exits the piston chamber 48 at the outlet pressure pout (4). Then the piston 46 moves forward and compresses the vapor left behind in the piston chamber 48 until the top dead point is reached again (1) and the cycle restarts. The piston 46 movement in this situation can be readily appreciated in FIGS. 4C and 4D.

By lagging the rotating inlet disk 44 relative to the piston displacement, the adjusted clearance volume V′ᵢₙ is larger than the clearance volume Vᵢₙ when the rotating inlet disk 44 does not lag relative to piston 46 displacement, as can be appreciated from FIGS. 4, 4A and 4C. Thus, the clearance volume (which can be appreciated from FIGS. 4, 4A and 4C), and mass flow rate, increases for the same given expander device 12 speed due to the lag in the alignment of the inlet port 58 and the inlet chamber opening 42. By having a variable timing of alignment the inlet port 58 with the inlet chamber opening 42, the mass flow rate of the WHR working vapor can be controlled independently of the expander device 12 speed and the conversion efficiency of the WHR system can be optimized.

In addition to the foregoing, a fixed displacement axial piston expander 12 with a variable clearance volume is also described. In this embodiment, the clearance volume at the top dead center of the piston stroke is made variable. In the depicted embodiment, the volume is made variable by sliding a movable part 62 in the piston chamber 48, as shown in FIG. 5.

In FIG. 5, the portion of the piston chamber 48 that moves is a portion of a cylinder head 64. While a cylinder head 64 is depicted, it can be appreciated that other portions of the piston chamber 48 can move in whole or in part. If the cylinder head 64 is selected as being the moving part just a portion of the head 64 can move as shown in FIG. 5, or the entire head 64 can move to create the variable clearance volume.

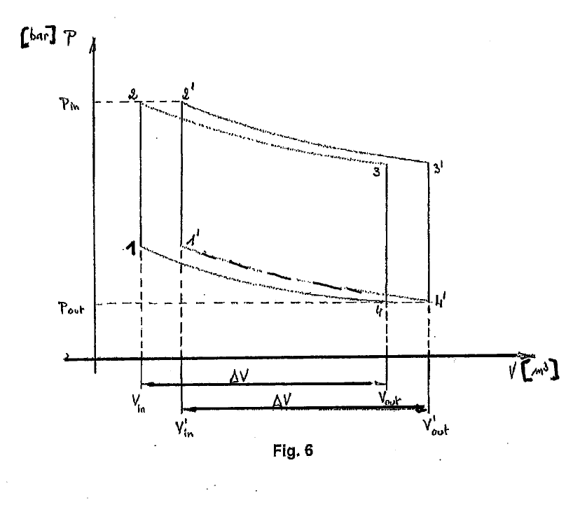

In FIG. 5, the cylinder head 64 can be moved in the axial direction away from the piston 46 to increase the clearance volume between the cylinder head 64 and piston 46. Thus, the mass flow rate of the expander device 12 can be altered independently of the expander device 12 speed. The expander device 12 cycle for at two different variable clearance volumes is represented in the pressure verse volume diagram of FIG. 6.

When the cylinder head 64 is in its initial position, or a first position, when the piston 46 reaches its top dead point (1) the inlet port 58 in the rotating inlet disk 44 matches the inlet opening 42 of the piston chamber 48 admitting the ORC working vapor to fill the clearance volume Vᵢₙ. The ORC working vapor enters the clearance volume Vᵢ at the top dead point at the inlet pressure pin (2). As the piston 46 moves backwards, the inlet disk 44 rotates further and closes the piston chamber 48. The working vapor expands until the bottom dead point of the piston 46 is reached, at which the outlet port opens (3). At the bottom dead point the vapor exits the piston chamber 48 and the pressure drops to the outlet pressure pout (4). Then the piston 46 moves forward and compresses the vapor left behind in the piston chamber 48 until the top dead point is reached again (1) and the cycle restarts.

A way to alter the mass flow rate at a given expander speed, is by adjusting the clearance volume of the expander device 12. The corresponding cycle is also represented in FIG. 6. By sliding the moving part 62 of the cylinder head 64 axially, the clearance volume increases to an adjusted clearance volume V′ᵢₙ in at a top dead point of the piston (1′) and working vapor enters the piston chamber 48 at the inlet pressure pin (2′). The vapor expands until the bottom dead point is reached (3′) at which point the outlet port 60 opens and the vapor exits the piston chamber 48 at the outlet pressure pout (4′). Then the piston 46 moves forward and compresses the vapor left behind in the piston chamber 48 until the top dead point is reached again (1′) and the cycle restarts. By sliding the moving part 62 of the cylinder head 64 only the clearance volumes Vᵢₙ and V′ᵢₙ in this case alters, but the displacement Δ V remains the same for both cycles as illustrated in FIG. 6

By making the clearance volume variable, the volume and mass flow rate, can be controlled independently of the expander device 12 speed and the conversion efficiency of the WHR system can be optimized. The system described above and depicted in FIG. 6 is only one possible solution amongst all available techniques to vary the clearance volume; the working principle however will remain the same.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

A method for improving the efficiency of an internal combustion engine,
comprising:
changing the volume in a piston chamber of an expander device having a fixed expander device speed to make the expander device perform work on a expander shaft connected to a first end of a piston on said piston chamber; and
selectively opening a fluid inlet port into said piston chamber when said piston reaches a predetermined point in said piston chamber axially away from a piston top dead point to permit vapor into said piston chamber thus changing the volume of the piston chamber, said vapor moving said piston axially away from said predetermined point.

2. The method of claim 1, wherein said vapor expands in said piston chamber and pushes said piston to a bottom dead point in said piston chamber.

3. The method of claim 1, wherein said piston chamber volume is changed by moving a portion of said piston chamber.

4. The method of claim 3, wherein said piston chamber comprises a cylinder head that is selectively moved when said piston is at a piston top dead point, which increases the piston chamber volume.

5. The method of claim 1, wherein said piston chamber is located within an expander device that receives vapor pumped from a connected heat exchanger.

6. The method of claim 5, wherein said piston is connected to an expander shaft that provides torque to an internal combustion engine output shaft.

7. The method of claim 6, wherein a swash plate connects said piston to said expander shaft to convert axial movement of said piston to rotational movement in said expander shaft.

8. A positive displacement expander device, comprising:
a piston chamber;
a piston located within said piston chamber;
an expander shaft connected to both a swash plate connected to said piston and a rotating inlet disk;
wherein said rotating inlet disk has an inlet port selectively matched with said piston chamber inlet opening and an outlet port selectively matched with said piston chamber inlet opening.

9. The positive displacement expander device of claim 8, wherein said piston chamber comprises a portion of a cylinder head that selectively moves to create a variable clearance volume in said piston chamber.
